(19) United States
(12) Patent Application Publication
(10) Pub. No.: US 2025/0348838 A1
(43) Pub. Date: Nov. 13, 2025

(54) ARTIFICIAL INTELLIGENCE FOR PROCUREMENT OF NUCLEAR FUEL

(71) Applicant: Florida Power & Light Company, Juno Beach, FL (US)

(72) Inventors: ROBERTO J. RIVERA, JUPITER, FL (US); EMILIO R. FUENTES, PALM CITY, FL (US); LORENZO ESTRADA, WEST PALM BEACH, FL (US); HANY F. BASSILY, OVIEDO, FL (US); MARSHALL SCOTT HYMAN, PALM CITY, FL (US); GREGORY S. DRAKE, PORT ST. LUCIE, FL (US); RICARDO L. RIVERA, PALM CITY, FL (US); DIEGO F. LOPEZ, JACKSONVILLE, FL (US); NAMASIVAYAM PIRAVIPERUMAL BALA SELVA, WESTLAKE, FL (US); ASHWIN KUNDURU, WELLINGTON, FL (US)

(21) Appl. No.: 18/660,451

(22) Filed: May 10, 2024

(51) Int. Cl. G06Q 10/087

(52) U.S. Cl. CPC G06Q 10/087

(57) ABSTRACT

Employing artificial intelligence to inform nuclear fuel procurement decisions is discussed. One example method includes accessing a database that characterizes terms of a set of transactions in a set of time frames. The transactions are transactions to procure material such as nuclear fuel assemblies or a precursor material for nuclear fuel assemblies obtained from procurement stages of a set of nuclear fuel procurement stages. The method also includes determining for the time frames, based on the database, a first range of values indicating a total expected supply of the material and a second range of values indicating a total expected demand for the material. The method further includes selecting an action in connection with the material from a set of potential actions, based on an analysis of the database, the first range of values, and the second range of values and outputting an indication of the selected action.

### TECHNICAL FIELD

This description relates to systems and methods that use artificial intelligence to inform decisions related to procurement of nuclear fuel and precursor materials.

### BACKGROUND

Production of nuclear fuel used in reactors (e.g., nuclear fuel assemblies comprising enriched uranium) involves multiple stages. In a mining and milling stage, natural uranium is extracted by mining. It is then treated with physical and chemical processes to produce U₃O₈ (yellowcake). In a conversion stage, the yellowcake is transformed into uranium hexafluoride gas (UF₆), which allows the enrichment to take place. In an enrichment stage, gas centrifuges are used to enrich the proportion of radioactive U-235 isotope from uranium's natural state of 0.7% to 2-5%. In a fabrication stage, enriched uranium is converted into uranium dioxide powder (or UO₂), which is compressed into pellets, encased in rods, and arranged into fuel assemblies. Fuel assemblies are placed into reactors during refueling outages.

### SUMMARY

A first example relates to a non-transitory machine-readable medium having machine executable instructions for a nuclear fuel procurement recommendation system that causes a processor core to execute operations. The operations include accessing a database that characterizes terms of a transaction of a set of transactions in a time frame of a set of time frames. The transaction is a transaction to procure a material obtained from a procurement stage of a set of nuclear fuel procurement stages, and the material is one of nuclear fuel assemblies or a precursor material for nuclear fuel assemblies. The operations also include determining for the time frame, based on the database, a first range of values indicating a total expected supply of the material and a second range of values indicating a total expected demand for the material. Additionally, the operations include selecting an action in connection with the material from a set of potential actions, based on an analysis of the database, the first range of values, and the second range of values. The operations further include outputting an indication of the selected action.

A second example relates to a nuclear fuel procurement recommendation system, including a memory for storing machine-readable instructions and a processor core for accessing the machine-readable instructions and executing the machine-readable instructions as operations. The operations include accessing a database that characterizes terms of a transaction of a set of transactions in a time frame of a set of time frames. The transaction is a transaction to procure a material obtained from a procurement stage of a set of nuclear fuel procurement stages, and the material is one of nuclear fuel assemblies or a precursor material for nuclear fuel assemblies. The operations also include determining for the time frame, based on the database, a first range of values indicating a total expected supply of the material and a second range of values indicating a total expected demand for the material. Additionally, the operations include selecting an action in connection with the material from a set of potential actions, based on an analysis of the database, the first range of values, and the second range of values. The operations further include outputting an indication of the selected action.

A third example relates to a method for generating a recommendation related to nuclear fuel procurement. The method includes accessing a database that characterizes terms of a transaction of a set of transactions in a time frame of a set of time frames. The transaction is a transaction to procure a material obtained from a procurement stage of a set of nuclear fuel procurement stages, and the material is one of nuclear fuel assemblies or a precursor material for nuclear fuel assemblies. The method also includes determining for the time frame, based on the database, a first range of values indicating a total expected supply of the material and a second range of values indicating a total expected demand for the material. Additionally, the method includes selecting an action in connection with the material from a set of potential actions, based on an analysis of the database, the first range of values, and the second range of values. The method further includes outputting an indication of the selected action.

### BRIEF DESCRIPTION OF THE DRAWINGS

FIG. 1 illustrates a diagram showing a nuclear fuel procurement recommendation system that generates recommendations regarding actions in connection with nuclear fuel procurement.

FIG. 2 illustrates a diagram showing the dependency of multiple different material contracts related to nuclear fuel procurement on each other, and on a demand for nuclear fuel assemblies to place in reactors.

FIG. 3 illustrates an example computing environment for a nuclear fuel procurement recommendation system.

FIG. 4 illustrates a flowchart of an example method for recommending a selected action in connection with nuclear fuel procurement.

FIG. 5 illustrates a flowchart of an example method for training and employing a machine-learning algorithm to recommend actions related to nuclear fuel procurement.

FIG. 6 illustrates a flowchart of an example method for employing a genetic algorithm to recommend actions related to nuclear fuel procurement.

### DETAILED DESCRIPTION

Various examples described herein generate recommendations for actions related to procurement of one or more materials such as: yellowcake that includes triuranium octoxide (U₃O₈) from a mining and milling stage, uranium hexafluoride (UF₆) gas from a conversion stage, enriched uranium hexafluoride (UF₆) gas from an enrichment stage, or nuclear fuel assemblies that include uranium dioxide (UO₂) from a fabrication stage. As used herein, “precursor material” includes any of the materials (e.g., yellowcake or U₃O₈, UF₆, enriched UF₆, etc.) other than nuclear fuel assemblies that are associated with nuclear fuel procurement and/or production.

The nuclear energy industry is heavily reliant on the efficient and effective procurement of nuclear fuel, which requires considerable expertise and resources. The current process is complex, manual, and time-consuming, with multiple spreadsheets tracking numerous contracts and factors to consider, and often results in inefficiencies and risks. As utilities and merchant plants face challenges such as market volatility, potential government regulations, and varying demand, there is a greater need for an intelligent and data-driven approach to optimize nuclear fuel procurement. Examples generate nuclear fuel procurement recommendations based on artificial intelligence, and provide an efficient, effective, and data-driven solution to the nuclear fuel procurement process.

Examples utilize advanced artificial intelligence (AI) and/or machine-learning (ML) modes (e.g., a genetic algorithm, a classification algorithm, a regression algorithm, etc.) to optimize the procurement of nuclear fuel for reactors. Various examples employ both genetic algorithms and machine learning models trained based on user feedback, such as a genetic algorithm that generates recommendations of optimum contract allocations considering all contractual constraints, based on a fitness metric (e.g., based on one or more of minimizing cost, acquisition time, excess inventory, etc.). Subsequent user feedback to such recommendations and created scenarios provide a foundation upon which the machine learning model(s) are trained to account for any factor which was not considered in the initial optimization process. Thus, such examples employ both optimization algorithm(s) and AI/ML model(s). These examples use accurately captured (e.g., manually, automatically, automatically with user feedback, etc.) terms and conditions of contracts involved in each phase of the nuclear fuel procurement process. Various examples identify triggers in contracts, both utility and merchant plants, and utilize data analytics and machine-learning algorithms to make predictions and recommendations. Additionally, examples account for different fuel procurement hedging strategy models for optimization based on market conditions. Recommendations include both optimization of existing contracts as well as predictions as to what ideal contract requirements are for open positions to be filled based on hedging conditions (e.g., requirements, preferences, etc.).

Various examples leverage a combination of internal and external data sources to provide real-time insights into the nuclear fuel market and current volume positions. Examples take into account various factors, such as price, availability, fuel requirements, internal data, and contract terms, to make accurate predictions and recommendations. Internal data includes leverage of the performance of past contracts or deals, such as by assessing the relative market conditions at the time a contract was obtained as compared with the actual market conditions at the time of delivery. Various examples optimize fuel procurement processes, enhancing operational efficiency, cost-effectiveness and reducing risk associated with fuel supply.

Examples enable organizations to proactively manage inventory levels accurately and provide real-time visibility across sites, effectively reducing the time required to procure fuel and increasing operational efficiency. Various examples can leverage AI/ML to drive significant improvements in cost, procurement strategy, inventory management for any or all nuclear fuel procurement stages, and overall performance. Thus, examples provide an efficient and effective solution to the complex and demanding requirements of nuclear fuel procurement in the modern energy sector.

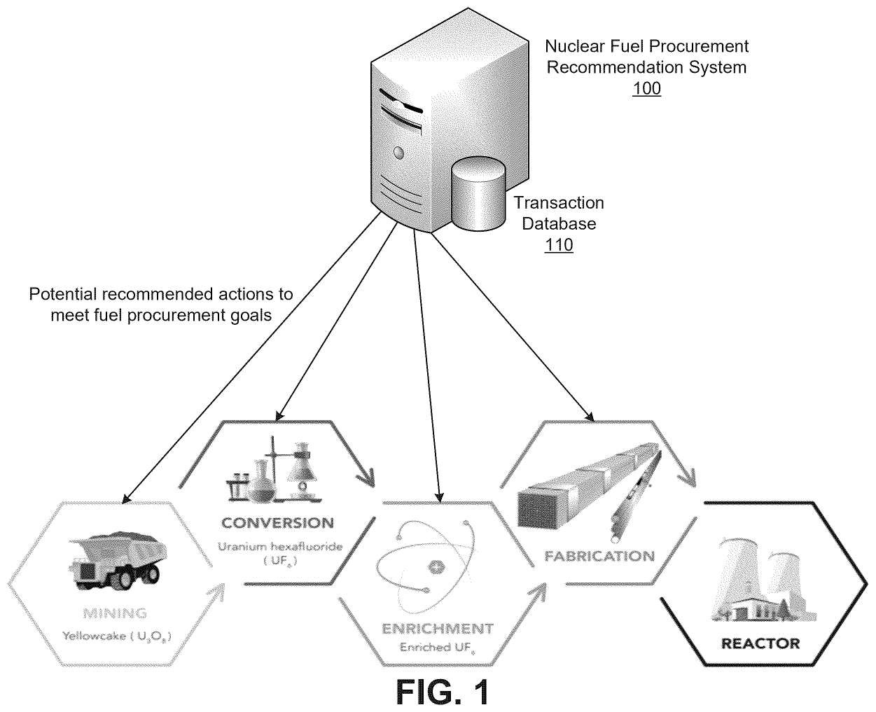

Referring to FIG. 1, illustrated is a diagram showing a nuclear fuel procurement recommendation system 100 that generates recommendations regarding actions in connection with nuclear fuel procurement. The system 100 is communicatively coupled to a transaction database 110, which includes terms and conditions of existing transactions related to nuclear fuel procurement. Based on terms and conditions of existing transactions, as well as other factors, such as market conditions, inventories or expected inventories of materials (e.g., yellowcake, UF₆, enriched UF₆, nuclear fuel assemblies, etc.), the system 100 recommends one or more actions (e.g., executing a recommended transaction, potentially at a recommended quantity; adding material to or using material from an inventory; entering into an additional transaction to convert, enrich, or fabricate a material from a feed material; entering into an additional transaction to buy or sell a material in a given time frame; selling rights under a transaction; etc.). In various examples, recommendations include optimization of existing contracts and/or predictions regarding ideal contract conditions to seek regarding open positions to be filled based on hedging conditions (e.g., requirements, preferences, etc.). Terms and conditions potentially include price; material conditions (e.g., feed material provided to obtain a material associated with a given stage, such as yellowcake, UF₆, or enriched UF₆, for conversion, enrichment, or fabrication, respectively) including timing, location, and quantity of materials (e.g., some transactions allow flexibility to be executed at a range of quantities, such as ±10%, ±15%, or +20% of a nominal quantity for the transaction) to be delivered for the transacted activities.

Nuclear fuel procurement frequently involves multiple transactions at various stages of the nuclear fuel procurement process, over a multi-year time frame (e.g., 5-7 years out, or potentially more). In connection with a mining stage, example transactions include transactions to obtain yellowcake (e.g., including U₃O₈) in various time frames. In connection with a conversion stage, example transactions include transactions to convert yellowcake to UF₆ or transactions to purchase UF₆ in various time frames. In connection with an enrichment stage, example transactions include transactions to enrich UF₆ or transactions to purchase enriched UF₆ in various time frames. In connection with a fabrication stage, example transactions include transactions to convert enriched UF₆ to UO₂ powder and construct nuclear fuel assemblies or transactions to purchase nuclear fuel assemblies in various time frames. To curtail risk associated with relying on a single transaction to provide a given material in a given time frame, multiple transactions are frequently used to obtain appropriate quantities of each material in any relevant time frames.

Additionally, inventories of various materials (e.g., yellowcake, UF₆, enriched UF₆, and nuclear fuel assemblies) and expected inventories at future time frames have levels that vary based on which transactions are executed and how they are executed.

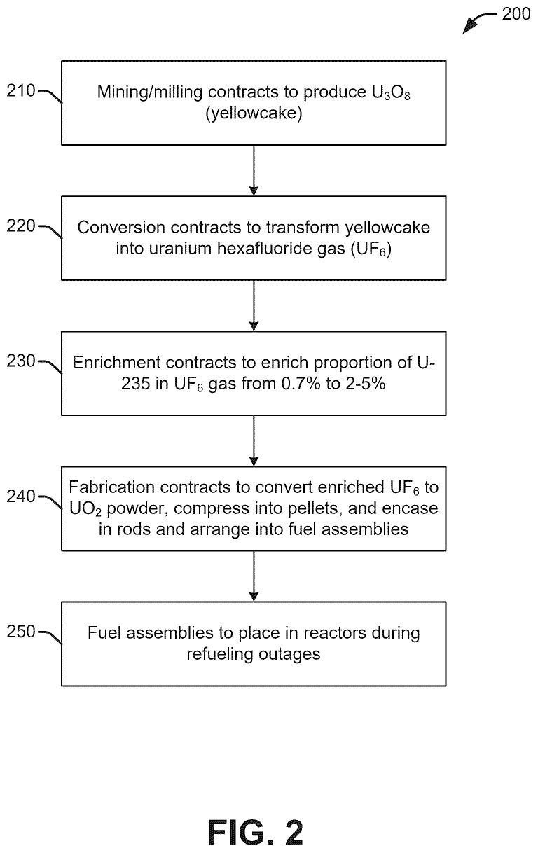

Referring to FIG. 2, illustrated is a diagram 200 showing the dependency of multiple different material contracts 210-240 on each other, and on a demand for nuclear fuel assemblies to place in reactors, at 250. Mining and milling contracts at 210 provide yellowcake that is used (along with potentially yellowcake inventory) as a feed material for conversion contracts at 220. In turn, conversion contracts at 220 provide UF₆ gas that is used (along with potentially UF₆ gas inventory) as a feed material for enrichment contracts at 230. Enrichment contracts at 230 provide enriched UF₆ gas that is used (along with potentially enriched UF₆ inventory) as a feed material for fabrication contracts at 240. Finally, fabrication contracts at 240 provide nuclear fuel assemblies that are used (along with potential nuclear fuel assembly inventory) to meet the refueling demands of one or more reactors. Each of these dependencies apply in each relevant time frame; for example, to have sufficient UF₆ gas for enrichment contracts at 230 in a first time frame involves having sufficient UF₆ gas from conversion contracts or inventory being available by that first time frame.

The refueling demand for sufficient nuclear fuel assemblies (e.g., at 250) can be met by purchased nuclear fuel assemblies, nuclear fuel assemblies from fabrication contracts at 240, nuclear fuel assemblies from an inventory, or from a combination of two or more. As a result, this creates a demand for sufficient enhanced UF₆ gas for fabrication contracts at 240, which creates a demand for sufficient UF₆ gas for enrichment contracts at 230, which in turns creates a demand for sufficient yellowcake (e.g., including from mining/milling contracts at 210) for conversion contracts at 220.

Because of the interdependence of the multiple stages and associated materials over multiple years, nuclear fuel procurement is inherently complex. Additionally, because of the risk associated with obtaining materials from a small number of sources, hedging strategies involving a larger number of transactions to obtain materials from a larger number of sources can be employed to reduce risk, but this further increases the complexity of managing nuclear fuel procurement. Furthermore, because procurement involves transactions over multiple years, changing circumstances (e.g., current or predicted price and/or availability of materials, etc.) further complicate procurement, often affecting multiple other stages of the procurement process at multiple other times (e.g., loss of access to an expected supply of yellowcake might leave insufficient yellowcake for future conversion contracts, in turn affecting enrichment contracts, fabrication contracts, and increasing the time to obtain nuclear fuel assemblies, etc.). As a result, the complexities of nuclear fuel procurement make it difficult to determine optimal or near-optimal procurement strategies.

Referring again to FIG. 1, however, various examples employ a nuclear fuel procurement recommendation system 100 that employs AI and/or ML to generate recommendations of actions to pursue procurement goals (e.g., time-related goals such as minimizing acquisition time of a material such as fuel assemblies, keeping acquisition time under a threshold time, or acquiring sufficient materials by a predetermined time; material-related goals such as ensuring an inventory level of a material is at least at a threshold level and/or is minimized while maintaining at least the threshold level; price-related goals; etc.). Various examples can employ different types of ML and/or AI algorithms to generate recommendations, such as a genetic algorithm that generates recommendations based on a fitness metric that represents procurement goals and/or a ML model that analyzes potential recommendations or scenarios based on procurement goals (e.g., one of or an ensemble of two or more of, a logistic regression model, a Cox regression model, a Least Absolute Shrinkage and Selection Operator (LASSO) regression model, a naïve Bayes classifier, a support vector machine (SVM) with a linear kernel, a SVM with a radial basis function (RBF) kernel, a linear discriminant analysis (LDA) classifier, a quadratic discriminant analysis (QDA) classifier, a logistic regression classifier, a decision tree, a random forest, a diagonal LDA, a diagonal QDA, a neural network, an AdaBoost algorithm, an elastic net, a Gaussian process classification, or a nearest neighbors classification, etc.). In various examples, the ML model is trained initially, based on user feedback to prior recommendations (e.g., from the genetic algorithm and/or the ML model, etc.), or both.

The recommendation system 100 generates recommendations based on terms of conditions of transactions represented by the transaction database 110, as well as other information such as market data (e.g., current and expected prices of materials, availability of materials, etc.), inventory levels of various materials, etc. In many examples, the recommendation system 100 generates recommendations for a current scenario of an operator of the recommendation system 100 based on existing transactions, inventory levels, market data, etc. In other examples, however, the recommendation system 100 generates recommendations for one or more hypothetical or potential scenarios, such as the current scenario modified in one or more respects (e.g., loss of supply of a material from a region, loss of one or more transactions, etc.), which allows an operator to easily consider the impact on procurement of various potential events (e.g., political or geopolitical events that affect supply of a material or transactions involving a region, etc.).

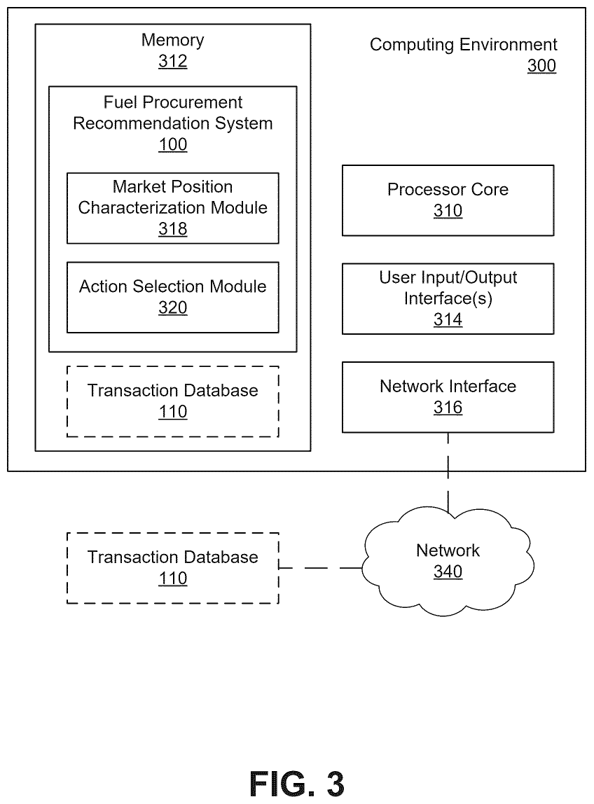

FIG. 3 illustrates an example computing environment 300 implementing a nuclear fuel procurement recommendation system 100 capable of generating a recommendation of an action to meet nuclear fuel procurement goals (e.g., reducing acquisition time for materials, minimizing an inventory level of a material while keeping the inventory level above a threshold value, etc.).

The computing environment 300 includes a processor core 310, a memory 312, a user input/output (I/O) interface 314, and a network interface 316, which are operably connected for computer communication. The processor core 310 performs general computing to execute instructions stored in the memory 312, including instructions associated with fuel procurement recommendation system 100. The instructions cause the processor core 310 to execute operations. The memory 312 also stores instructions associated with an operating system that controls and/or allocates resources of computing environment 300, including resources associated with the fuel procurement recommendation system 100 of FIG. 1. The memory 312 represents a non-transitory machine-readable memory (or other medium), such as random access memory (RAM), a solid state drive, a hard disk drive or a combination thereof.

The fuel procurement recommendation system 100 includes a market position characterization module 318 and an action selection module 320. The memory 312 stores machine-readable instructions associated with the position characterization module 318 and the action selection module 320. In various examples, the action selection module 320 selects potential actions based on a current or potential scenario as represented by data stored in the transaction database 110 (e.g., characterizing terms and conditions of transactions) and the market position characterization module 318 (e.g., characterizing actual or expected inventory levels, market conditions, etc.). Based on the selected actions, the fuel procurement recommendation system 100 generates procurement recommendations.

The transaction database 110 characterizes terms and conditions (e.g., time, quantity, price, etc.) of transactions related to procurement of nuclear fuel assemblies or precursor materials. Depending on the example, the transaction database can be stored locally to, remotely from, or a combination of locally to and remotely from the computing environment 300. In various examples, data in the transaction database 110 characterizing terms and conditions of transactions is entered manually, automatically generated (e.g., via a ML algorithm trained on a training set of transactions with known terms and conditions provided to the algorithm and validated on a validation set of transactions with known terms and conditions not provided to the algorithm, etc.), or automatically generated subject to user modification (e.g., which can also be used for further training of the ML algorithm, etc.).

The processor core 310 accesses the memory 312 and executes the machine-readable instructions as operations. The processor core 310 can be a variety of various processors including multiple single- and multi-core processors, co-processors, and other multiple single and multicore processor and co-processor architectures.

The user I/O interface 314 provides software and hardware to facilitate data input and output between the computing environment 300 and a user. This can include input devices such as a keyboard, mouse, touchpad, touchscreen, microphone, etc., as well as output devices such as display(s) (e.g., light-emitting diode (LED) display panel(s), liquid crystal display (LCD) panel(s), plasma display panel(s), and/or touch screen display(s), etc.), speaker(s), etc. The user I/O interface 314 provides graphical input controls for a user interface, which can include software and hardware-based controls, interfaces, touch screens, or touch pads or plug and play devices for a user to provide user input.

The network interface 316 provides software and hardware to facilitate data input to (e.g., terms and conditions in the transaction database 110 when stored at least partially locally, data related to material inventory or market conditions, etc.) and output from (e.g., terms and conditions in the transaction database 110 when stored at least partially remotely, procurement action recommendations, etc.) the computing environment 300.

The memory 312 includes the fuel procurement recommendation system 100 that includes modules 318 and 320 that operate in concert and/or stages to generate a recommended action in connection with nuclear fuel procurement.

In various examples, the market position characterization module 318 stores data representing current and/or expected market conditions (e.g., price, availability, etc.) for materials (e.g., yellowcake, UF₆, enriched UF₆, nuclear fuel assemblies) and/or services to obtain materials from feed materials (e.g., conversion, enrichment, fabrication, etc.). Additionally, the market position characterization module 318, in various examples, stores inventory data representing current and/or expected inventories of materials associated with nuclear fuel procurement.

The action selection module 320 accesses data (e.g., from the transaction database 110 and the market position characterization module 318) and analyzes the accessed data with an AI or ML algorithm in connection with one or more time frames. Based on the analysis, the action selection module 320 selects one or more recommended actions in connection with nuclear fuel procurement, which are then output. In various examples, recommended actions include one or more of executing a transaction (e.g., recommending a quantity of feed material to provide in connection with a flexible contract, etc.), obtaining a quantity of material from an inventory (e.g., for use as feed material for a contract), storing a quantity of material in an inventory, attempting to obtain one or more additional transactions for material (e.g., buying the material or a service to obtain the material from a feed material), attempting to sell a quantity of material or to sell rights under a transaction to obtain material, etc.

In various examples, the action selection module 320 identifies actions for recommendation based on one or more of actual or estimated supply (e.g., from transactions, etc.) of material in a time frame, actual or estimated demand (e.g., as feed material for transactions, for refueling, etc.) for material in the time frame, actual or estimated market conditions in the time frame or in one or more other time frames, actual or estimated material(s) in inventory in the time frame, etc.

In various examples, analysis by the action selection module 320 is based on one or more of a genetic algorithm or a trained machine-learning (e.g., regression, etc.) algorithm.

In examples employing a genetic algorithm, the action selection module 320 generates a starting set of candidate actions for nuclear fuel procurement, and selects a subset based on a fitness metric that characterizes one or more procurement goals (e.g., reducing time to acquisition of nuclear fuel assemblies, maintaining and/or minimizing inventory levels of materials within a selected range, etc.). The action selection module 320 applies one or more genetic operators (e.g., crossover, mutation, regrouping, colonization-extinction, migration, etc.) to the selected subset to generate a new candidate set of actions. The action selection module 320 performs subset selection and application of genetic operator(s) over multiple operations, and stops based on one or more conditions (e.g., reaching a fixed number of iterations, reaching a threshold value for the fitness metric, a lack of improvement of the fitness metric over one or more iterations, etc.). After stopping the genetic algorithm, the action selection module outputs one or more of the best actions (as determined based on the fitness metric) as recommendations.

In examples employing a trained machine-learning (e.g., regression, etc.) algorithm, the action selection module 320 employs the trained algorithm to generate one or more recommended actions. The ML algorithm employed by the action selection module is initially trained based on a training set of potential actions (e.g., some recommended, some non-recommended, etc.) associated with known values (e.g., classification values of recommended or non-recommended, or fitness values such as based on a fitness metric, etc.) provided to the ML algorithm. In various examples, the trained ML algorithm is validated based on a validation set of potential actions associated with known values that are not provided to the ML algorithm. Additionally, in various examples, the ML algorithm is further trained based on user feedback to prior recommended actions provided to the action selection module 320.

In examples employing both a genetic algorithm and ML algorithm, the action selection module 320 employs the genetic algorithm to generate one or more initial recommended actions based on optimizing a fitness metric (e.g., minimizing cost, acquisition time, excess inventory, etc.), and subsequent user feedback (e.g., received via the user I/O interface 314 and/or the network interface 316) to such recommendations and to created scenarios generate a foundation upon which the machine learning models will be trained by the action selection module 320 to account for any factor(s) not considered in the initial optimization process.

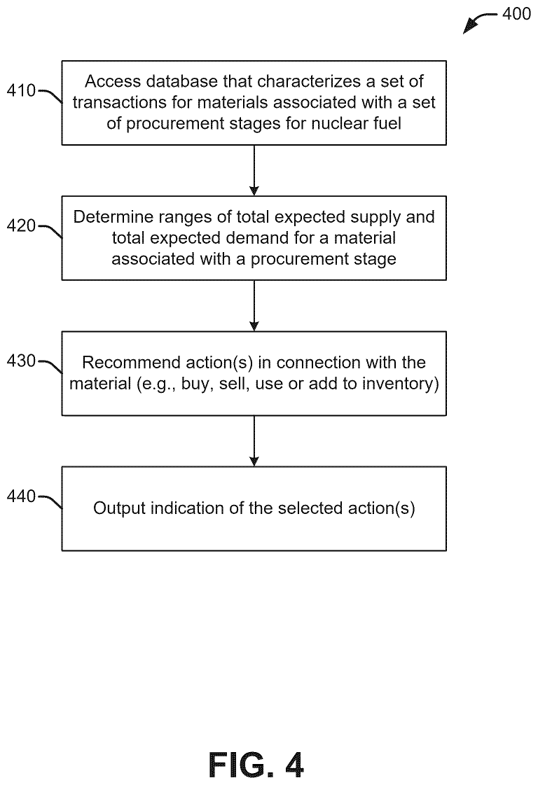

In view of the foregoing structural and functional features described above, an example method will be better appreciated with reference to FIGS. 4, 5, and 6. While, for purposes of simplicity of explanation, the example method of FIGS. 4-6 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

FIG. 4 illustrates a flowchart of an example method 400 for recommending a selected action in connection with nuclear fuel procurement. In other examples, the blocks of example method 400 are a set of machine-readable instructions on a non-transitory machine-readable medium or are a set of operations performed by a processor executing machine-readable instructions as the operations.

At block 410, the method 400 includes accessing a database (e.g., the transaction database 110) that characterizes terms and conditions of a set of transactions related to various stages of nuclear fuel procurement (e.g., procurement of nuclear fuel assemblies or one or more precursor materials, etc.).

At block 420, the method 400 includes determining total expected supply and total expected demand of material(s) in one or more time frames. In some scenarios, mismatches between supply and demand create situations to be resolved by additional procurement actions (e.g., adding to inventory, removing from inventory via selling or use as feed material, obtaining additional material via transaction(s), executing transactions based on recommendations such as quantity of feed material, removing a transaction by selling rights under the transaction, etc.). Even without mismatches, in some scenarios, additional actions advance fuel procurement goals such as reducing time or average time to obtain nuclear fuel assemblies, management of inventory, etc., and the expected supply and demand inform the range of potential actions.

At block 430, the method 400 includes selecting a recommended action from a set of potential actions, based on data such as the terms and conditions of relevant transactions, the expected supply, the expected demand, and/or current or expected market conditions. In various examples, a genetic algorithm and/or a trained ML algorithm is employed to select the recommended action.

At block 440, the method 400 includes outputting an indication of the selected action.

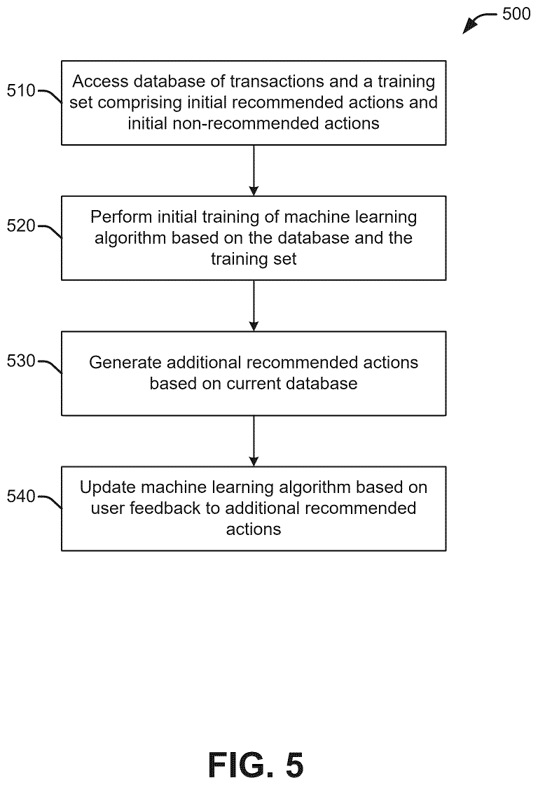

FIG. 5 illustrates a flowchart of an example method 500 for training and employing a machine-learning algorithm to recommend actions related to nuclear fuel procurement. In other examples, the blocks of example method 500 are a set of machine-readable instructions on a non-transitory machine-readable medium or are a set of operations performed by a processor executing machine-readable instructions as the operations.

At block 510, the method 500 includes accessing a database that characterizes terms and conditions of a set of transactions related to nuclear fuel procurement and a training set of potential actions with known values (e.g., recommended or non-recommended, a score based on a fitness metric, etc.) that are provided to a machine-learning algorithm.

At block 520, the method 500 includes performing initial training of the machine-learning algorithm based on the database and the training set. In some examples, validation of the trained machine-learning algorithm is also performed based on a validation set of potential actions with known values (e.g., recommended or non-recommended, a score based on a fitness metric, etc.) that are not provided to a machine-learning algorithm. Based on the results of validation, additional training is performed in some examples.

At block 530, the method 500 includes generating one or more additional recommendations from the trained ML algorithm based on a current state of the database (e.g., to include additional transactions, etc.).

At block 540, the method 500 includes updating the machine-learning algorithm based on user feedback to the one or more additional recommendations. In various examples, blocks 530 and 540 are repeated as recommendations are generated over time.

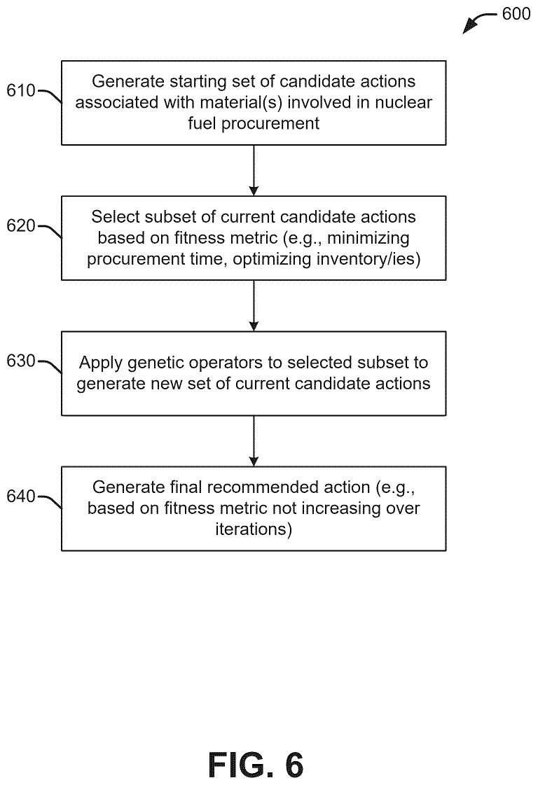

FIG. 6 illustrates a flowchart of an example method 600 for employing a genetic algorithm to recommend actions related to nuclear fuel procurement. In other examples, the blocks of example method 600 are a set of machine-readable instructions on a non-transitory machine-readable medium or are a set of operations performed by a processor executing machine-readable instructions as the operations.

At block 610, the method 600 includes generating an initial set of candidate actions related to nuclear fuel procurement based on one or more of a database that characterizes terms and conditions of a set of transactions, current or expected market conditions, current or expected inventories of materials, etc.

At block 620, the method 600 includes selecting a subset of a current set of candidate actions (e.g., an initial set of candidate actions or a subsequent set of candidate actions, etc.) based on a fitness metric that characterizes one or more procurement goals (e.g., minimizing procurement time, optimizing inventories, etc.).

At block 630, the method 600 includes applying one or more genetic operators to the selected subset to generate a subsequent set of candidate actions. In various examples, blocks 620 and 630 are repeated over multiple iterations until a termination condition is met (e.g., reaching a fixed number of iterations, reaching a threshold value for the fitness metric, a lack of improvement of the fitness metric over one or more iterations, etc.).

At block 640, the method 600 includes generating a final recommended action, such as an action with a highest fitness metric value of a final set of recommended actions.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Also as used herein, the term “set” means one or more elements (e.g., where the elements can be anything, such as datasets, nodes, relationships, etc.), and a “subset” of a set A refers to any set B where every element of set B is an element of set A (note that every set A is a subset of itself, as every element of set A is an element of set A). Similarly, a “proper subset” of set A refers a set B that does not include every member of the set A, such that set A and set B are not equal. Additionally, where the disclosure or claims recite “a,” “an,” “a first,” or “another” element, or the equivalent thereof, it should be interpreted to include one or more than one such element, neither requiring nor excluding two or more such elements.

In this description, unless otherwise stated, “about,” “approximately” or “substantially” preceding a parameter means being within +/−10 percent of that parameter. Modifications are possible in the described embodiments, and other embodiments are possible, within the scope of the claims.

What is claimed is:

1. A non-transitory machine-readable medium having machine executable instructions for a nuclear fuel procurement recommendation system that causes a processor core to execute operations, the operations comprising:
accessing a database that characterizes terms of a transaction of a set of transactions in a time frame of a set of time frames, wherein the transaction is a transaction to procure a material obtained from a procurement stage of a set of nuclear fuel procurement stages, and the material is one of nuclear fuel assemblies or a precursor material for nuclear fuel assemblies;
determining for the time frame, based on the database, a first range of values indicating a total expected supply of the material and a second range of values indicating a total expected demand for the material;
selecting an action in connection with the material from a set of potential actions, based on an analysis of the database, the first range of values, and the second range of values; and
outputting an indication of the selected action.

2. The non-transitory machine-readable medium of claim 1, wherein selecting the action comprises employing a genetic algorithm to identify the selected action based on a fitness metric.

3. The non-transitory machine-readable medium of claim 2, wherein the fitness metric is based on one of maintaining an inventory of the material within a third range of values or reducing an average time associated with the set of nuclear fuel procurement stages.

4. The non-transitory machine-readable medium of claim 1, wherein selecting the action comprises employing a machine-learning algorithm to identify the selected action, and the machine-learning algorithm is trained based on user feedback associated with a set of previously selected actions.

5. The non-transitory machine-readable medium of claim 1, wherein the selected action comprises selecting a quantity of the material for the transaction.

6. The non-transitory machine-readable medium of claim 1, wherein the selected action comprises increasing the first range of values by obtaining a quantity of the material for the time frame via one of an additional transaction or reducing an inventory of the material.

7. The non-transitory machine-readable medium of claim 1, wherein the selected action comprises reducing the first range of values by one of selling the transaction or increasing an inventory of the material.

8. The non-transitory machine-readable medium of claim 1, wherein the selected action comprises increasing the second range of values by obtaining a quantity of another material obtained from another procurement stage of the set of nuclear fuel procurement stages for the time frame via one of an additional transaction or reducing an inventory of the other material.

9. The non-transitory machine-readable medium of claim 1, wherein the selected action comprises reducing the second range of values by one of selling another transaction or increasing an inventory of another material obtained from another procurement stage of the set of nuclear fuel procurement stages.

10. The non-transitory machine-readable medium of claim 1, wherein the procurement stage is a mining and milling stage and the material is yellowcake comprising triuranium octoxide (U₃O₈).

11. The non-transitory machine-readable medium of claim 1, wherein the procurement stage is a conversion stage and the material is uranium hexafluoride (UF₆) gas.

12. The non-transitory machine-readable medium of claim 1, wherein the procurement stage is an enrichment stage and the material is enriched uranium hexafluoride (UF₆) gas.

13. The non-transitory machine-readable medium of claim 1, wherein the procurement stage is a fabrication stage and the material is the nuclear fuel assemblies.

14. The non-transitory machine-readable medium of claim 1, wherein the total expected demand for the material is based on a total expected demand for an additional material obtained from a next procurement stage of the set of nuclear fuel procurement stages.

15. A nuclear fuel procurement recommendation system, comprising:
a memory for storing machine-readable instructions; and
a processor core for accessing the machine-readable instructions and executing the machine-readable instructions as operations, the operations comprising:
accessing a database that characterizes terms of a transaction of a set of transactions in a time frame of a set of time frames, wherein the transaction is a transaction to procure a material obtained from a procurement stage of a set of nuclear fuel procurement stages, and the material is one of nuclear fuel assemblies or a precursor material for nuclear fuel assemblies;
determining for the time frame, based on the database, a first range of values indicating a total expected supply of the material and a second range of values indicating a total expected demand for the material;
selecting an action in connection with the material from a set of potential actions, based on an analysis of the database, the first range of values, and the second range of values; and
outputting an indication of the selected action.

16. The nuclear fuel procurement recommendation system of claim 15, wherein selecting the action comprises employing a genetic algorithm to identify the selected action based on a fitness metric.

17. The nuclear fuel procurement recommendation system of claim 15, wherein the database characterizes the transaction based on an automated analysis of a document associated with the transaction.

18. A method for generating a recommendation related to nuclear fuel procurement, the method comprising:
accessing a database that characterizes terms of a transaction of a set of transactions in a time frame of a set of time frames, wherein the transaction is a transaction to procure a material obtained from a procurement stage of a set of nuclear fuel procurement stages, and the material is one of nuclear fuel assemblies or a precursor material for nuclear fuel assemblies;
determining for the time frame, based on the database, a first range of values indicating a total expected supply of the material and a second range of values indicating a total expected demand for the material;
selecting an action in connection with the material from a set of potential actions, based on an analysis of the database, the first range of values, and the second range of values; and
outputting an indication of the selected action.

19. The method of claim 18, wherein the selecting of the action is based on a characterization of market conditions associated with one of the material or another material obtained from another procurement stage of the set of nuclear fuel procurement stages.

20. The method of claim 18, wherein selecting the action comprises employing a machine-learning algorithm to identify the selected action, and the machine-learning algorithm is trained based on user feedback associated with a set of previously selected actions.
